(19) United States
(12) Patent Application Publication
(10) Pub. No.: US 2008/0148699 A1
(43) Pub. Date: Jun. 26, 2008

(54) FILTERING ELEMENT FOR AIR-FILTER

(75) Inventors: Makoto SAZAWA, Kariya-shi (JP); Kazuaki TAKEUCHI, Handa-shi (JP); Yoshihisa SANAMI, Obu-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 11/962,723

(22) Filed: Dec. 21, 2007

(30) Foreign Application Priority Data
Dec. 26, 2006 (JP) 2006-350178

(51) Int. Cl. B01D 46/10

(52) U.S. Cl. 55/498; 55/514

(57) ABSTRACT

A filtering element for air filter is formed by joining an upstream layer arranged upstream in flow direction of air integrally with a downstream layer located downstream in the flow direction of the air. The upstream layer collects dust from the air and the downstream layer supports the upstream layer. The upstream layer is formed through press forming of a nonwoven fabric formed of fibers having an average diameter of 0.5 μm to 2.5 μm. The thickness of the upstream layer is set to 0.005 mm to 0.1 mm, and the porosity of the upstream layer is set to 78% to 92%. The downstream layer is normally formed by a filter paper layer. The press forming is performed preferably at 20° C. to 160° C. and 1 MPa to 5 MPa. The mass per unit area of the upstream layer is preferably 1 g/cm² to 15 g/cm². The density of the fibers forming the nonwoven fabric is 0.9 g/cm³ to 1.5 g/cm³.

### BACKGROUND OF THE INVENTION

The present invention relates to a filtering element for an air filter that is used as, for example, a filter of an engine intake system of an automobile or an air conditioner to collect dust from air.

Conventionally, as one such filtering element for air filter, a filtering element formed by a nonwoven fabric layer and a filter paper layer is known. The nonwoven fabric layer is arranged upstream and the filter paper layer downstream in the flow direction of the air. Filtering accuracy of this filtering element is set to increase in the flow direction of the air. Thus, the mesh size of the nonwoven fabric layer arranged upstream is greater than the mesh size of the filter paper layer located downstream. As a result, the nonwoven fabric layer, or the upstream layer, collects relatively large-sized particles of dust and the filter paper layer, or the downstream layer, catches relatively small-sized particles. Only mass per unit area is set for the nonwoven fabric layer and the filter paper layer of the filtering element. Other factors than the mass per unit area, such as the diameter of fibers forming the nonwoven fabric layer, are not particularly considered.

However, even if the mass per unit area is unchanged, the mesh size of the nonwoven fabric layer or the filter paper layer increases as the fiber diameter increases. In contrast, as the fiber diameter decreases, the mesh size reduces. Thus, the mesh size of the nonwoven fabric layer or the filter paper layer cannot be determined only from the mass per unit area. For example, if the mesh size of the upstream layer, or the nonwoven fabric layer, is excessively small, clogging may easily occur upstream in the flow direction of the air. In this case, the downstream layer, or the filter paper layer, cannot perform the filtering effectively. This decreases the amount of the dust collected by the filtering element. In contrast, if the mesh size of the nonwoven fabric layer, or the upstream layer, is excessively great, a large amount of dust particles pass through the nonwoven fabric layer and are collected by the filter paper layer. This increases the load on the filter paper layer and the filter paper layer may be easily clogged. As a result, the amount of the dust caught by the air filtering element is reduced.

To solve this problem, as described in Japanese Laid-Open Patent Publication No. 2006-175352, the applicant of the present application has proposed a filtering element for a filter that increases the amount of collected dust by setting the mesh size of a nonwoven layer, or an upstream layer, in an optimal range. The filtering element is formed by the nonwoven fabric layer, which is arranged upstream, and a filtering element layer, which is located downstream. The diameter of each of resin fibers forming the nonwoven fabric layer is 2.5 μm to 10 μm. The mass per unit area of the nonwoven fabric layer is 2.5 g/m² to 15 g/m². The mesh size of the filtering element layer is smaller than the mesh size of the nonwoven fabric layer.

The diameter of each resin fiber, which forms the nonwoven fabric layer of this filtering element, is set in a low range of 2.5 μm to 10 μm. However, to increase the amount of the collected dust, the diameter of each resin fiber must be set to a lower level. As the fiber diameter decreases, porosity, which represents proportion of spaces defined between the fibers, decreases. This increases airflow resistance of the air and decreases the size of the spaces that collect the dust, thus reducing the dust collection amount. That is, the filtering element for the filter of Japanese Laid-Open Patent Publication No. 2006-175352 does not sufficiently increase the collection amount of the dust when the airflow resistance is maintained.

### SUMMARY OF THE INVENTION

Accordingly, it is an objective of the present invention to provide a filtering element for an air filter that suppresses air resistance and increases dust collection amount.

To achieve the foregoing objective and in accordance with one aspect of the present invention, a filtering element for air filter including an upstream layer and a downstream layer is provided. The upstream layer is arranged at an upstream position in a flow direction of air. The upstream layer collects dust from the air, and is formed through press forming of a nonwoven fabric formed of fibers having an average diameter of 0.5 μm to 2.5 μm. The thickness of the upstream layer is 0.005 mm to 0.1 mm. The porosity of the upstream layer is 78% to 92%. The downstream layer is located at a downstream position in the flow direction of the air. The downstream layer supports the upstream layer, and is formed integrally with the upstream layer.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view taken along line 1-1 of FIG. 5, schematically showing a honeycomb structure forming a filter device according to one embodiment of the present invention;

FIG. 2 is a cross-sectional view schematically showing another type of honeycomb structure different from the type shown in FIG. 1;

FIG. 3 is a cross-sectional view schematically showing an air filter device;

FIG. 4 is a schematic view showing a device for manufacturing a nonwoven fabric using a melt-blown method; and

FIG. 5 is a cross-sectional view schematically showing the honeycomb structure.

### DETAILED DESCRIPTION OF THE PREFERRED EMBODIMENTS

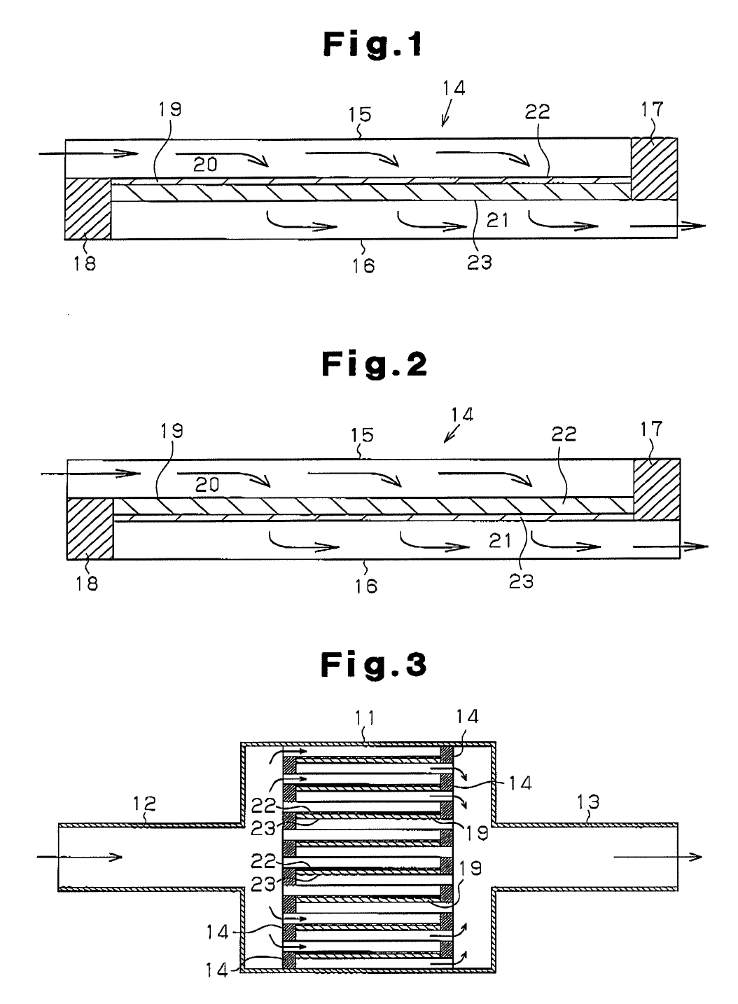

An embodiment of the present invention, which is believed to be the best mode for carrying out the invention, will be explained in detail with reference to the drawings. FIG. 3 is a cross-sectional view schematically showing an air filter device. As shown in FIG. 3, an air inlet pipe 12 into which air containing dust is introduced is connected to a front portion of an air filter element 11 (left side as viewed in FIG. 3). An air outlet pipe 13 through which clean air without the dust is sent is connected to a rear portion of the air filter element 11 (right side as viewed in FIG. 3). The air filter element 11 is formed by a honeycomb structure 14 including air filtering elements 19 that is spirally wound. FIGS. 1 and 2 are cross-sectional views each schematically show the honeycomb structure 14. FIG. 1 is a cross-sectional view taken along line 1-1 of FIG. 5. As shown in FIG. 1, the honeycomb structure 14 has an upper partition wall 15 arranged above the air filtering element 19, a lower partition wall 16 located below the air filtering element 19, a rear end closing portion 17 arranged at the rear end (the right end as viewed in FIG. 1) of the air filtering element 19, and a front end closing portion 18 located at the front end (the left end as viewed in FIG. 1) of the air filtering element 19.

The space between the air filtering element 19 and the upper partition wall 15 defines an inlet space 20 into which the air containing the dust is introduced along the corresponding arrows of FIG. 1. The space between the air filtering element 19 and the lower partition wall 16 defines an outlet space 21 into which clean air is discharged. Specifically, the air containing the dust is introduced through the inlet space 20, flows as indicated by arrows of FIG. 1, and passes through the filtering element 19. The dust is thus removed from the air and clean air is sent to the outlet space 21. In other words, the flow of the air in the honeycomb structure 14 includes an inlet flow flowing through the inlet space 20 and an outlet flow passing through the outlet space 21. The inlet flow becomes the outlet flow after having passed through the air filtering element 19, which removes the dust from the air. The air filtering element 19 is arranged parallel with the flow direction of the air. That is, the air filtering element 19 is located parallel with the flow direction of the inlet flow flowing from upstream to downstream (from the left to the right as viewed in FIG. 1) in the inlet space 20 and the flow direction of the outlet flow flowing from upstream to downstream in the outlet space 21 (from the left to the right as viewed in the drawing). This prevents the dust removed from the air from being easily deposited on the surface of the air filtering element 19. The dust is thus sent to an inner portion of the air filtering element 19, and dust collection performance is enhanced.

The dust in the air includes organic or inorganic substances. The organic substances include, for example, organic compounds and organic polymers. The inorganic substances include, for example, dirt, smoke, mist, ash, and metal particles. The average particle size of most types of the dust particles is 0.1 μm to 100 μm. The particles with this size are removed in an upstream layer 22. The air filtering element 19 has the upstream layer (a nonwoven fabric layer) 22, which is arranged upstream in the flow direction of the air, and a downstream layer (a filter paper layer) 23, which is located downstream. The upstream layer 22 and the downstream layer 23 are stacked together as an integral body. The upstream layer 22 catches the dust from the air and the downstream layer 23 supports (reinforces) the upstream layer 22.

In the case illustrated in FIG. 1, the thickness of the upstream layer 22 is smaller than the thickness of the downstream layer 23. In the case illustrated in FIG. 2, the thickness of the upstream layer 22 is greater than the thickness of the downstream layer 23. The upstream layer 22 is formed of a nonwoven fabric through press forming. The nonwoven fabric is formed of fibers having an average diameter of 0.5 μm to 2.5 μm. The thickness of the upstream layer 22 is set to 0.005 mm to 0.1 mm and the porosity of the upstream layer 22 is set to 78% to 92%. The fibers are not particularly restricted to certain types and may be, for example, synthetic fibers or natural fibers. The synthetic fibers include, for example, polyester fibers, polypropylene fibers, polyamide (Nylon) fibers, and acrylic fibers. The natural fibers include, for example, cotton, pulp, and rayon fibers. The types of the fibers are selected in correspondence with required air permeability, required dust collection performance, and required rigidity of a target product. The fibers may be formed of a single specific type or different types in combination. The fibers are not particularly restricted to a specific shape but may be straight fibers or crimped fibers. The shape of each fiber is selected in correspondence with a required amount of fibers (fiber density) with respect to the thickness of the upstream layer 22, a required rigidity of the upstream layer 22, and a required air permeability of the upstream layer 22. The fibers may be formed by fibers that have a common specific shape or combination of fibers that have different shapes.

Each of the fibers may have a circular or rectangular cross section. The cross-sectional shape of the fiber is selected in correspondence with the required air permeability, the required dust collection performance, and the required rigidity of a target product. The fibers may be fibers that have a common specific cross-sectional shape or combination of fibers that have different cross-sectional shapes. If the air filtering element 19 is used as filters in automobiles, it is preferred that polyester fibers, which exhibit stability under heat, are used as main components and mixed with appropriate amounts of polypropylene fibers, acrylic fibers, or pulp.

As has been described, the average diameter of each of the above-described fibers is set to 0.5 μm to 2.5 μm. If the average fiber diameter is less than 0.5 μm, the fibers cannot be formed with productivity maintained at a favorable level. If the average fiber diameter is more than 2.5 μm, the mesh size of the upstream layer 22 increases and the dust collection amount becomes insufficient.

The above-described press forming is performed at 20° C. to 160° C. and 1 MPa to 5 MPa so as to sufficiently compress the fibers and decrease the mesh size of the upstream layer 22. To carry out the press forming effectively, it is preferred that the procedure is carried out at 120° C. to 150° C. If the press forming is performed at a temperature less than 20° C., the fibers are subjected to the press shaping substantially in a cold state. In this case, compression of the fibers tend to become insufficient and nonuniform. If the press forming is performed at the temperature exceeding 160° C., fibers formed of resin, or resin fibers, for example, become soft. This makes it difficult to set the thickness of the upstream layer 22 to a desired level. Further, the thickness of the upstream layer 22 may become non-uniform. If the press forming is carried out under pressure less than 1 MPa, the pressure is insufficient. This makes it difficult to set the thickness of the upstream layer 22 to the desired level and decrease the mesh size of the upstream layer 22. If the press forming is performed at pressure exceeding 5 MPa, setting of the thickness of the upstream layer 22 to the desired level and adjustment of the mesh size of the upstream layer 22 to a desired size tend to become difficult.

Through such press forming, the thickness of the upstream layer 22 is set to 0.005 mm to 0.1 mm. By setting the thickness of the upstream layer 22 in this range, a sufficient dust collection amount is ensured and airflow resistance is decreased. If the thickness of the upstream layer 22 is less than 0.005 mm, the dust collection amount is ensured to a certain extent but the airflow resistance becomes excessively great. If the thickness of the upstream layer 22 exceeds 0.1 mm, the airflow resistance is reduced but the dust collection amount does not reach a target value.

The porosity of the upstream layer 22 is determined in correspondence with the mass per unit area and the thickness of the upstream layer 22 and the density of fiber in the nonwoven fabric forming the upstream layer 22, using the following equation (1):

Porosity(%)=1−[mass per unit area of the upstream layer 22/(thickness of the upstream layer 22×density of fiber in the nonwoven fabric)] (1)

The porosity calculated by the equation (1) is set to 78% to 92% to equilibrate the dust collection amount with the airflow resistance, as has been described. Since the thickness of the upstream layer 22 is set in the aforementioned range, the porosity is calculated by selecting the types of the fibers forming the nonwoven fabric and determining the mass per unit area of the upstream layer 22. In other words, the mass per unit area of the upstream layer 22 is obtained by selecting the types of the fibers forming the nonwoven fabric and determining the porosity. If the porosity is less than 78%, the dust collection amount does not reach the target value. This causes clogging of the upstream layer 22 and increases the airflow resistance. If the porosity exceeds 92%, the airflow resistance decreases but the dust collection amount does not reach the target value.

To ensure a sufficient amount of fibers per unit area of the upstream layer 22 and improve the dust collection performance, it is preferred that the mass per unit area of the upstream layer 22 is 1 g/m² to 15 g/m². If the mass per unit area of the upstream layer 22 is less than 1 g/m², the amount of the fibers per unit area becomes insufficient and the dust collection performance tends to lower. If the mass per unit area of the upstream layer 22 exceeds 15 g/m², the dust collection performance improves but the airflow resistance in the upstream layer 22 may increase.

To maintain the porosity of the upstream layer 22, reduce the airflow resistance, and enhance the dust collection performance, it is preferred that the density of the fibers in the nonwoven fabric is 0.9 g/cm³ to 1.5 g/cm³. It the density of the fibers is less than 0.9 g/cm³, the porosity of the upstream layer 22 tends to increase and the dust collection performance may decrease. If the density of the fibers exceeds 1.5 g/cm³, the porosity of the upstream layer 22 tends to decrease. This may reduce the dust collection performance and raise the airflow resistance.

To maintain flow of the air containing the dust and prevent clogging of the upstream layer 22, it is preferred that the airflow resistance of the upstream layer 22 when the upstream layer 22 retains the dust is 0.8 kPa to 1.8 kPa. If the airflow resistance of the upstream layer 22 is less than 0.8 kPa, the flow of the air is maintained but the dust collection amount may become insufficient. If the airflow resistance of the upstream layer 22 exceeds 1.8 kPa, the flow of the air in the upstream layer 22 is easily stopped and the life of the upstream layer 22 tends to be shortened. In the following description, the upstream layer 22 of the illustrated embodiment is formed of resin fibers spun by a melt-blown method, which will be explained layer, or fibers of thermoplastic resin.

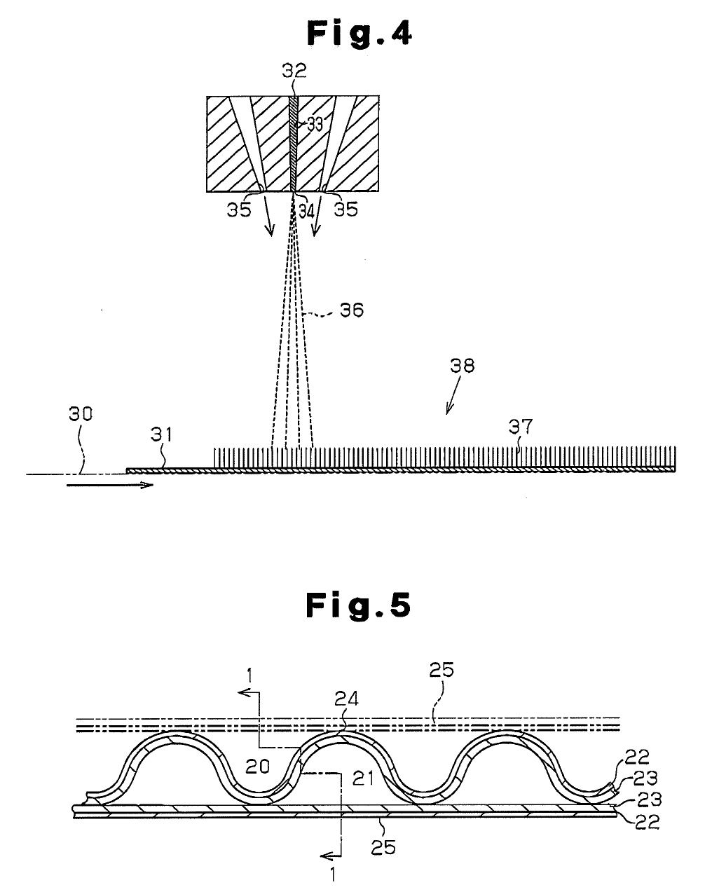

An apparatus and a method for manufacturing the upstream layer 22 will hereafter be explained. As shown in FIG. 4, the apparatus has a conveyor 30 that moves horizontally. A belt-like base fabric 31 is mounted on the conveyor 30. A spinning nozzle 33, which ejects molten resin 32 downwardly, is arranged above the conveyor 30. The base fabric 31 is formed in a meshed manner and has air permeability. The base fabric 31 receives the molten resin 32.

The spinning nozzle 33 operates in accordance with the melt-blown method. Specifically, a resin ejection port 34 is formed at the center of the spinning nozzle 33 and ejects the molten resin 32. A hot air blower port 35 is formed around the resin ejection port 34 and blows hot air onto the molten resin 32. In this manner, a resin fiber 36 is spun. The resin ejection port 34 and the hot air blower port 35 each have a tapered shape and the diameters of these components become smaller downwardly. The resin fibers 36 spun by the spinning nozzle 33 are blown by the hot air and stacked on the base fabric 31 in a semi-molten state. The resin fibers 36 contact one another on the base fabric 31 and are thus fusion-bonded at the contact points. In this manner, a nonwoven fabric 38 is provided. As the conveyor 30 is actuated, the nonwoven fabric 38 is transported while mounted on the conveyor 30. The nonwoven fabric 38 is then subjected to the press forming under the above-described conditions to provide the upstream layer 22. Then, a filter paper, which is to form the downstream layer 23, is bonded with the upstream layer 22. In this manner, a flat plate-like filtering element 25, which serves as the air filtering element 19, is provided.

By adjusting the amount of the resin ejected from the resin ejection port 34 of the spinning nozzle 33 and the flow of the hot air blown from the hot air blower port 35, the average diameter of each of the resin fibers 36, which form the upstream layer 22, is set in a predetermined range. For example, if the average fiber diameter is set to a small value, the diameter of the spinning nozzle 33 is set also to a small value and the flow of the hot air blown from the hot air blower port 35 increases. In the illustrated embodiment, in the air filtering element 19, the average diameter of each resin fiber 36 is set to 0.5 μm to 2.5 μm, as has been described.

The mass per unit area of the upstream layer 22 is set in a predetermined range by adjusting the movement speed of the conveyor 30. Specifically, reducing the movement speed of the conveyor 30 increases the amount of the resin fibers 36 stacked on the base fabric 31 and the mass per unit area of the upstream layer 22. In contrast, as the movement speed of the conveyor 30 increases, the amount of the resin fibers 36 stacked on the base fabric 31 and the mass per unit area of the upstream layer 22 both decrease. In the air filtering element 19 according to the illustrated embodiment, it is preferred that the mass per unit area of the upstream layer 22 is 1 g/m² to 15 g/m², as described above.

Subsequently, the downstream layer 23 will be explained. The downstream layer 23 is usually a filter paper layer. The downstream layer 23 may be formed of nonwoven fabric or woven fabric of synthetic fibers. The thickness of the downstream layer 23 is approximately 0.01 mm to 0.14 mm. The average diameter of a filter bore in the downstream layer 23 is set to 10 μm to 100 μm. The downstream layer 23 is configured in such a manner as to allow the air that has passed through the upstream layer 22 to move through the downstream layer 23 without resistance. The downstream layer 23 is formed of pulp or a material mainly containing the pulp and synthetic fibers such as polyester fibers, polypropylene fibers, or polyamide fibers, in addition to the pulp. The small-sized particles of the dust that have passed through the upstream layer 22 may be removed from the air by the downstream layer 23.

The upstream layer 22 and the downstream layer 23 are bonded together through embossing or lamination. In embossing, the upstream layer 22 and the downstream layer 23 are stacked together and clamped together using a plurality of heated small projections from above and blow. Portions of the upstream layer 22 are thus molten and bonded with the downstream layer 23. In lamination, a hot-melt sheet with high air permeability is placed between the upstream layer 22 and the downstream layer 23. By heating and pressurizing the hot-melt sheet, the upstream layer 22 and the downstream layer 23 are bonded together through the hot-melt sheet. The thickness of the air filtering element 19 is the sum of the thickness of the upstream layer 22 and the thickness of the downstream layer 23, which is 0.02 mm to 0.25 mm.

A corrugated roller is then pressed against the flat plate-like filtering element 25 having an elongated shape, which is formed by the upstream layer 22 and the downstream layer 23 that are bonded together. This provides an elongated corrugated filtering element 24 serving as the air filtering element 19. Subsequently, with reference to FIG. 5, the corrugated filtering element 24 is mounted on a different flat plate-like filtering element 25. The corrugated filtering element 24 and the flat plate-like filtering element 25 are wound and bonded together using adhesive. In this manner, the corrugated filtering element 24 and the flat plate-like filtering element 25 are joined together as an integral body. In this state, corresponding ones of the longitudinal ends of the inlet space 20 and the outlet space 21, which are defined by the corrugated filtering element 24 and the flat plate-like filtering element 25, are closed with adhesive. Specifically, only one of the ends of the inlet space 20 and the outlet space 21 that are located adjacently in the lateral directions of these spaces 20, 21 is closed by the adhesive.

In this manner, the rear end closing portion 17 and the front end closing portion 18 are provided. The honeycomb structure 14, which is shown in FIG. 3, is thus formed. The upper partition wall 15 corresponds to the flat plate-like filtering element 25 arranged at an upper side in FIG. 5. The lower partition wall 16 corresponds to the flat plate-like filtering element 25 located at a lower side of the drawing. A hot-melt adhesive may be applied to at least one of the flat plate-like filtering element 25 and the corrugated filtering element 24. In this case, when bonding the flat plate-like filtering element 25 with the corrugated filtering element 24, the bonding portions of the flat plate-like filtering element 25 or the corrugated filtering element 24 are heated to melt the adhesive. The flat plate-like filtering element 25 and the corrugated filtering element 24 are then cured so that the flat plate-like filtering element 25 and the corrugated filtering element 24 are bonded together.

As a result, with reference to FIGS. 1 to 3, the inlet space 20 having a semispherical shape as viewed along the longitudinal direction is defined with the upstream end open and the downstream end closed. Further, the outlet space 21 is defined adjacent to the inlet space 20 with the upstream end closed and the downstream end open. In this state, the corrugated filtering element 24 and the flat plate-like filtering element 25 are joined together in such a manner that the upstream layers 22 of the filtering elements 24, 25 are arranged at a position corresponding to the inlet side of the air.

The air filtering element 19 of the illustrated embodiment is formed by joining the upstream layer 22 with the downstream layer 23, as viewed in the air flow direction. The upstream layer 22 is provided through press forming of the nonwoven fabric 38, which is formed by depositing the resin fiber layer 37 on the base fabric 31 using the melt-blown method. In the press forming, since the thickness of the upstream layer 22 is reduced to 0.005 to 0.1 mm, the resin fibers 36 are compressed and the mesh size of the resin fibers 36 decreases in the entire upstream layer 22. This facilitates the removal of the dust from the air. In addition to the thickness of the upstream layer 22, the density of the resin fibers 36 forming the nonwoven fabric is set in accordance with the type of the resin fibers 36. In this manner, the mass per unit area of the upstream layer 22 is determined. The porosity is thus set to 78 to 92% in correspondence with the thickness, density, and mass per unit area of the upstream layer 22. Further, since average diameter of each resin fiber 36 is set to 0.5 μm to 2.5 μm, the air permeability is maintained and the duct collection performance is improved. As a result, the upstream layer 22 collects the dust from the air with improved effectiveness and maintains the air permeability.

The illustrated embodiment has the following advantages.

In the air filtering element 19 of the illustrated embodiment, the average diameter of the resin fibers 36 is set to 0.5 μm to 2.5 μm with the porosity of the upstream layer 22 maintained at 78% to 92%. This suppresses the air-flow resistance of the air filtering element 19 and increases the amount of the collected dust. Further, the upstream layer 22 is pressed to the thickness of 0.005 μm to 0.1 μm. The resin fibers 36 are thus compressed and the mesh size of the upstream layer 22 is reduced so that the upstream layer 22 collects an increased amount of dust. Accordingly, the air filtering element 19 is effectively used as a filter of an engine intake system of an automobile or a filter of an air conditioner.

The press forming is performed at 20° C. to 160° C. and 1 MPa to 5 MPa. This sufficiently compresses the resin fibers 36 to a reduced mesh size. The press forming is carried out effectively since the procedure is performed at 120° C. to 150° C.

By setting the mass per unit area of the upstream layer 22 to 1 g/m² to 15 g/m², the mass of the resin fibers 36 per unit area reaches a sufficiently great level. The dust collection performance is thus enhanced.

By setting the density of the resin fibers 36 forming the nonwoven fabric 38 to the 0.9 g/cm³ to 1.5 g/cm³, the porosity is maintained, the air-flow resistance is decreased, and the dust collection performance is improved.

Using the melt-blown method, the upstream layer 22 is easily formed. Further, since the melt-blown method does not involve the use of organic solvent, which is used in a conventional electrostatic spinning method, the load on the environment is reduced and the manufacturing cost is saved.

Since the air filtering element 19 is arranged parallel with the flow direction of the air, clogging in the surface of the upstream layer 22 is suppressed and the amount of the collected dust is increased. Further, the life of the air filtering element 19 is prolonged.

Since the air-flow resistance of the upstream layer 22 with the dust retained by the upstream layer 22 is set to 0.8 kPa to 1.8 kPa, the flow of the air containing the dust is maintained and the flow of the air is prevented from stopping.

By spirally winding the air filtering element 19, dust is efficiently collected in a small space.

It should be apparent to those skilled in the art that the present invention may be embodied in many other specific forms without departing from the spirit or scope of the invention. Particularly, it should be understood that the invention may be embodied in the following forms.

The nonwoven fabric 38 may be formed of a combination of a plurality of types of resin fibers 36 with different properties. In this case, the density of the resin fibers 36 in the entire portion of the nonwoven fabric 38 is easily adjusted. Alternatively, each resin fiber 36 may be formed of two or more different materials. This facilitates adjustment of the density of the resin fibers 36.

The upstream layer 22 may be formed solely by the flat plate-like filtering element 25 or the corrugated filtering element 24.

After being formed by the melt-blown method, the upstream layer 22 may be passed through heated rolls. This improves smoothness of the surface of the upstream layer 22.

In the melt-blown method, an additive element may be added to the resin fibers 36. As the additive element, viscosity modifier such as sodium polyacrylate, fiber binding agent such as binder fiber, fiber slip improving agent such as nonionic surface active agent, or dispersion stabilizer such as carboxymethylcellulose may be used.

Although the illustrated embodiment will hereafter be explained in further detail with reference to examples and comparative example, the present invention is not restricted to the examples.

### Examples 1 to 5 and Comparative Examples 1 to 11

In Examples 1 to 5, polyethylene terephthalate (PET) resin was used as the fibers forming the upstream layer 22. The density of the PET resin was 1.4 g/cm³. The nonwoven fabric 38 was formed using the above-described apparatus shown in FIG. 4. The obtained nonwoven fabric 38 was subjected to press forming at 120° C. and 3 MPa to form the upstream layer 22. A filter paper, which was to form the downstream layer 23, was bonded with the upstream layer 22 and the flat plate-like filtering element 25 was obtained. A corrugated roller was then pressed against the flat plate-like filtering element 25 to form the corrugated filtering element 24. As illustrated in FIG. 5, the corrugated filtering element 24 was mounted on the flat plate-like filtering element 25. The corrugated filtering element 24 and the flat plate-like filtering element 25 were then wounded and bonded together using adhesive. The honeycomb structure 14 was thus provided. The thickness of the upstream layer 22 of each of the examples was set to the values in Table 1. The thickness of the downstream layer 23 was 0.14 mm, and the average diameter of the filter bore in the downstream layer 23 was 60 μm.

By adjusting the amount of the resin ejected from the resin ejection port 34 of the spinning nozzle 33 and the flow rate of the hot air blown from the hot air blower port 35, the average diameter and the mass per unit area of the resin fibers 36, which forms the upstream layer 22, were set to the values of Table 1. The porosity of the upstream layer 22 was calculated using the equation (1). Air containing a certain amount of dust was supplied to the upstream layer 22 and the amount (g) of the collected dust and the air-flow resistance (kPa) were measured. The results are shown in Table 1.

Comparative examples 1 to 11 were carried out in accordance with Examples 1 to 5 but under the following conditions that were different from the corresponding conditions of the examples. In Comparative Examples 1 and 3, the porosity of the upstream layer 22 was set to less than 78%. In Comparative Examples 2, 4, 5, 6, 7, 8, 9, and 11, press forming was not performed, the thickness of the upstream layer 22 was more than 0.1 mm and the porosity was more than 92%. In Comparative Example 10, the porosity was more than 92%. In the comparative examples, the dust collection amount (g) and the air-flow resistance (kPa) were measured in the same manner as Example 1. The results are shown in Table 2.

### Comparative Examples 6 to 9

In Examples 6 and 7, the fibers forming the upstream layer 22 were formed of polypropylene (PP) resin instead of PET resin. The honeycomb structure 14 was formed in the same manner as Example 1, except that the mass per unit area and the porosity of the upstream layer 22 were set as represented in Table 1. The density of the PP resin was 0.95 g/cm³. In Examples 8 and 9, polyamide (Nylon) resin was used, instead of the PET resin, as the material of the fibers forming the upstream layer 22. The honeycomb structure 14 was formed in the same manner as Example 1, except that the mass per unit area and the porosity of the upstream layer 22 were set as shown in Table 1. The density of the polyamide (Nylon) resin was 1.14 g/cm³. The dust collection amount (g) and the air-flow resistance (kPa) were measured in the same manner as Example 1. The results are shown in Table 1.

TABLE 1

| | Average | | | | | |
|---|---|---|---|---|---|---|
| | Diameter of | | | | | |
| | Resin Fiber | Mass per | | | | |
| | forming | Unit Area of | Thickness | Porosity of | Dust | |
| | Upstream | Upstream | of Upstream | Upstream | Collection | Air-flow |
| | Layer | Layer | Layer | Layer | Amount | Resistance |
| | (μm) | (g/cm²) | (mm) | (%) | (g) | (kPa) |
| Example 1 | 1.5 | 15.0 | 0.05 | 78.6 | 75.1 | 1.71 |
| Example 2 | 1.5 | 10.0 | 0.04 | 82.1 | 89.5 | 1.44 |
| Example 3 | 2.5 | 5.0 | 0.03 | 88.1 | 85.9 | 1.21 |
| Example 4 | 1.5 | 1.5 | 0.01 | 89.3 | 90.2 | 0.80 |
| Example 5 | 1.5 | 5.0 | 0.04 | 91.1 | 82.5 | 1.14 |
| Example 6 | 1.5 | 5.0 | 0.03 | 88.0 | 85.5 | 1.39 |
| Example 7 | 1.5 | 7.0 | 0.05 | 89.2 | 87.3 | 1.29 |
| Example 8 | 1.5 | 5.0 | 0.04 | 87.2 | 88.5 | 0.98 |
| Example 9 | 1.5 | 7.0 | 0.06 | 88.1 | 85.2 | 0.98 |

TABLE 2

| | Average | | | | | |
|---|---|---|---|---|---|---|
| | Diameter of | | | | | |
| | Resin Fiber | Mass per | | | | |
| | forming | Unit Area of | Thickness | Porosity of | Dust | |
| | Upstream | Upstream | of Upstream | Upstream | Collection | Air-flow |
| | Layer | Layer | Layer | Layer | Amount | Resistance |
| | (μm) | (g/cm²) | (mm) | (%) | (g) | (kPa) |
| Comparative | 3.5 | 15.0 | 0.04 | 73.2 | 45.0 | 2.21 |
| Example 1 | | | | | | |
| Comparative | 3.5 | 15.0 | 0.90 | 98.8 | 41.8 | 2.09 |
| Example 2 | | | | | | |
| Comparative | 2.5 | 20.0 | 0.06 | 76.2 | 52.5 | 2.45 |
| Example 3 | | | | | | |
| Comparative | 2.5 | 20.0 | 1.00 | 98.6 | 43.0 | 2.11 |
| Example 4 | | | | | | |
| Comparative | 1.5 | 15.0 | 0.90 | 98.8 | 42.2 | 1.91 |
| Example 5 | | | | | | |
| Comparative | 1.5 | 10.0 | 0.70 | 99.0 | 40.5 | 1.80 |
| Example 6 | | | | | | |
| Comparative | 2.5 | 5.0 | 0.40 | 99.1 | 39.9 | 1.78 |
| Example 7 | | | | | | |
| Comparative | 1.5 | 1.5 | 0.20 | 99.5 | 38.1 | 1.45 |
| Example 8 | | | | | | |
| Comparative | 1.5 | 5.0 | 0.40 | 99.1 | 39.2 | 1.58 |
| Example 9 | | | | | | |
| Comparative | 1.5 | 0.9 | 0.01 | 94.6 | 47.9 | 1.20 |
| Example 10 | | | | | | |
| Comparative | 1.5 | 0.9 | 0.15 | 99.6 | 37.2 | 1.29 |
| Example 11 | | | | | | |

With reference to Table 1, the thickness of the upstream layer 22 was set to 0.01 mm to 0.05 mm through the press forming in Examples 1 to 5. The average diameter of the resin fibers 36 was set to 1.5 μm to 2.5 μm and the porosity of the upstream layer 22 was 78% to 92%. As a result, the dust collection amount was not less than 75 g, or a target value of a filter used in, for example, an engine intake system of an automobile. The air-flow resistance was not more than 1.71 kPa. In Examples 6 to 9, the resin material was changed to the PP type or the polyamide type. The density of the resin material was set to 0.95 or 1.14. Further, the thickness of the upstream layer 22 was set to 0.03 mm to 0.06 mm through press forming. The average diameter of the resin fibers 36 was set to 1.5 μm and the porosity of the upstream layer 22 was set to 88% to 90%. As a result, the dust collection amount was 85 g to 89 g and the air-flow resistance was reduced to 0.9 pKa to 1.4 pKa.

As is clear from Table 2, in Comparative Examples 1 and 3, the porosity of the upstream layer 22 was less than 78%. The dust collection amount was thus less than the aforementioned target value and the air-flow resistance was increased. In Comparative Example 10, the porosity exceeded 92% and the air-flow resistance was low. However, the dust collection amount was less than the target value. In Comparative Examples 2, 4, 5, 6, 7, 8, 9, and 11, the press forming was not carried out and the thickness of the upstream layer 22 was more than 0.1 mm. Further, the porosity of the upstream layer 22 exceeded 92%, reducing the air-flow resistance to a low level. However, the dust collection amount was less than the target value.

Therefore, the present examples and embodiments are to be considered as illustrative and not restrictive and the invention is not to be limited to the details given herein, but may be modified within the scope and equivalence of the appended claims.

1. A filtering element for air filter comprising:
an upstream layer arranged at an upstream position in a flow direction of air, the upstream layer collecting dust from the air, the upstream layer being formed through press forming of a nonwoven fabric formed of fibers having an average diameter of 0.5 μm to 2.5 μm, a thickness of the upstream layer being 0.005 mm to 0.1 mm, a porosity of the upstream layer being 78% to 92%; and
a downstream layer located at a downstream position in the flow direction of the air, the downstream layer supporting the upstream layer, the downstream layer being formed integrally with the upstream layer.

2. The filtering element according to claim 1, wherein the press forming is performed at a temperature of 20° C. to 160° C. and under a pressure of 1 MPa to 5 MPa.

3. The filtering element according to claim 1, wherein a mass per unit area of the upstream layer is 1 g/m² to 15 g/m².

4. The filtering element according to claim 1, wherein a density of fibers forming the nonwoven fabric is 0.9 g/cm³ to 1.5 g/cm³.

5. The filtering element according to claim 1, wherein the filtering element is arranged parallel with the flow direction of the air when used.

6. The filtering element according to claim 1, wherein an air-flow resistance of the upstream layer when having collected dust from the air is 0.8 kPa to 1.8 kPa.

7. The filtering element according to claim 1, wherein the filtering element is spirally wound when used.

8. The filtering element according to claim 1, wherein the press forming is performed at a temperature of 120° C. to 150° C.
